(19) United States
(12) Patent Application Publication
(10) Pub. No.: US 2015/0166844 A1
(43) Pub. Date: Jun. 18, 2015

(54) Substrate Comprising High and Low Gloss Areas with a Physical Microstructure Superimposed Thereon

(71) Applicant: 3M INNOVATIVE PROPERTIES COMPANY, St. Paul, MN (US)

(72) Inventors: Graham M. Clarke, Woodbury, MN (US); Joseph T. Bartusiak, Osseo, MN (US)

(21) Appl. No.: 14/380,888

(22) PCT Filed: Jan. 30, 2013
(86) PCT No.: PCT/US2013/023841

§ 371 Date: Aug. 25, 2014

Related U.S. Application Data
(60) Provisional application No. 61/604,124, filed on Feb. 28, 2012.

(51) Int. Cl. C09J 7/02; B29B 11/12

(52) U.S. Cl. CPC C09J 7/0264; B29B 11/12; B29L 2031/00

(57) ABSTRACT

Polymeric substrates with a first major side including first, high-gloss areas and also including second, low-gloss areas that comprise a molded textured surface, the first and second areas being provided on the first major surface in a predetermined pattern; and wherein the first major side of the substrate further includes at least one physical microstructure that is superimposed on the first, high-gloss areas and on the second, low-gloss areas.

### BACKGROUND

Substrates with physical microstructures thereon have been used for various purposes.

### SUMMARY

Herein are disclosed polymeric substrates with a first major side including first, high-gloss areas and also including second, low-gloss areas that comprise a molded textured surface, the first and second areas being provided on the first major surface in a predetermined pattern; and wherein the first major side of the substrate further includes at least one physical microstructure that is superimposed on the first, high-gloss areas and on the second, low-gloss areas. Also disclosed are methods of making such polymeric substrates.

These and other aspects of the invention will be apparent from the detailed description below. In no event, however, should the above summaries be construed as limitations on the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of a portion of an exemplary substrate comprising first, high-gloss areas, and second, low-gloss areas, and further comprising an exemplary physical microstructure superimposed on the first and second areas.

FIG. 2 is a side schematic cross sectional view of a portion of an exemplary substrate comprising first, high-gloss areas, and second, low-gloss areas, and further comprising another exemplary physical microstructure superimposed on the first and second areas.

FIG. 3 is a top plan view of the first major side of an exemplary substrate comprising first high-gloss areas and second low-gloss areas, and further comprising an exemplary physical microstructure superimposed on the first and second areas.

FIG. 4 is a top plan view of the first major side of another exemplary substrate comprising first high-gloss macroscopic regions and second low-gloss macroscopic regions, and further comprising an exemplary physical microstructure superimposed on the first and second regions.

FIG. 5 is a perspective view of an exemplary physical microstructure that comprises a hand-tear pattern, superimposed on first high-gloss areas and second low-gloss areas.

FIG. 6 is a perspective view of an exemplary physical microstructure that comprises a liquid-retention pattern, superimposed on first high-gloss areas and second low-gloss areas.

FIG. 7 is a perspective view of an exemplary physical microstructure that comprises coextensive, intersecting hand-tear and liquid-retention patterns, superimposed on first high-gloss areas and second low-gloss areas.

FIG. 8 is a diagrammatic view of an exemplary process for making a microstructured tape backing and tape.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as top, bottom, upper, under, over, front, back, up and down, and first and second may be used in this disclosure, it should be understood that those terms are used in their relative sense only unless otherwise noted. The terms outward and inward refer to directions generally away from the interior of substrate 1, and toward the interior of substrate 1, respectively. Terms such as same, equal, uniform, constant, and the like, as applied to a quantifiable property or attribute, mean within +/−5%, unless otherwise specifically defined. As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties); the term “substantially” means to a high degree of approximation (e.g., within +/−10% for quantifiable properties) but again without requiring absolute precision or a perfect match. Terms such as high/higher, and low/lower, as used with respect to gloss, are specifically defined below.

### DETAILED DESCRIPTION

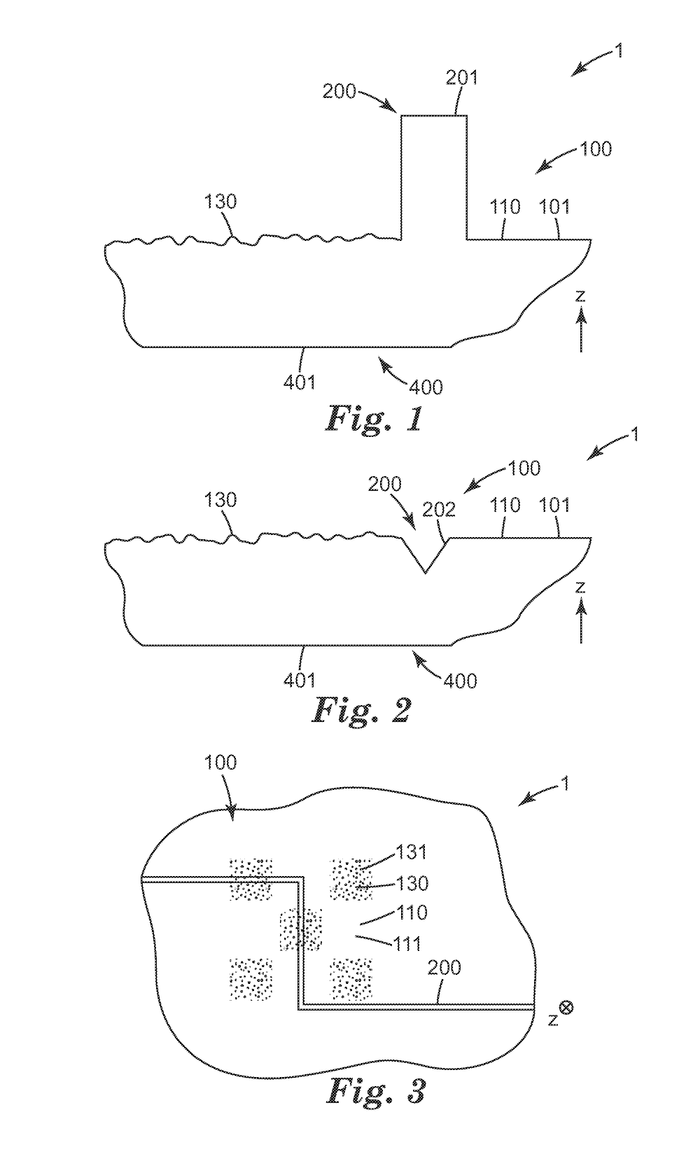

Shown in FIGS. 1 and 2 are side cross-sectional perspective views of exemplary substrates 1, each comprising first major side 100 and second major side 400, which respectively comprise first and second oppositely-facing major surfaces 101 and 401. First major surface 101 of first major side 100 comprises first areas 110 of high gloss. First major surface 101 further comprises second areas 130 of low gloss. By high gloss and low gloss is specifically meant that the gloss of areas 130 is lower than that of areas 110. Areas 130 may exhibit this lower gloss by way of comprising a molded surface texture. In this context, an area 130 with molded surface texture denotes an area with features that deviate (along the z-axis of substrate 1, as depicted in FIG. 1) from a flat planar surface in such manner as to lower the gloss of area 130 from that which would be exhibited by a flat surface, as discussed in detail later herein. By molded textured surface is meant that the texture-imparting features of major surface 101 of substrate 1 are obtained by, and during, the molding of substrate 1. As such, a molded textured surface may be distinguished from a textured surface obtained from treating of an existing surface (e.g., obtained from abrading, ablating, or physical roughening of such a surface, or from depositing texture-imparting materials thereonto). First and second areas 110 and 130 are provided in a predetermined pattern.

First major side 100 of substrate 1 further comprises at least one physical microstructure 200 that is superimposed on first and second areas 110 and 130. By superimposed is meant that such microstructure or microstructures 200 extends into and/or through at least some of first, high-gloss areas 110, and also extends into and/or through at least some of second, low-gloss areas 130 (as seen most easily e.g. in the representative illustration of FIG. 3).

In various embodiments, low-gloss areas 130 with molded textured surfaces may exhibit a gloss of less than about 40, 20, 10, 5, or 2 gloss units. In some embodiments low-gloss areas 130 may exhibit a matte finish (appearance), as will be recognizable to the ordinary artisan. In various embodiments, high-gloss areas 110 may exhibit a gloss of at least 20, 40, 60, or 80 gloss units. In various embodiments, low-gloss areas 130 may exhibit a gloss that is lower than that of high-gloss areas 110, by at least 5, 10, 20, 40, or 60 gloss units (irrespective of the absolute value of the gloss units of the respective areas), e.g. so as to provide sufficient contrast in gloss that a difference in the character of visible light reflected from the high-gloss and the low-gloss areas is perceivable by an observer.

Such gloss measurements may be performed locally, e.g. by whatever method and apparatus that can provide gloss measurements on a local scale, or that can provide parameters that can be correlated with gloss units (such methods might include e.g. profilometry, confocal microscopy, etc.). Or, such gloss measurements may be performed on macroscopic regions collectively formed by high-gloss areas and similarly on macroscopic regions collectively formed by low-gloss areas (such macroscopic regions are discussed later herein). Such measurements may be performed with conventional gloss meters e.g. such as the gloss meter available from BYK Additives and Instruments of Columbia, Md., under the trade designation MICRO-TRI GLOSS (and may be measured e.g. in generally similar manner to the procedures found in ASTM Test Methods D2457-08 and D523-08, both as specified in 2008). It will be appreciated that such gloss measurements are often performed at a 60 degree angle of incidence; however (for example in the event that a particular design of physical microstructure 200 might unduly interfere with gloss measurements at 60 degrees, e.g., by a shadowing effect), the gloss measurements can be performed at an angle at which any effect of the physical microstructure is minimized, e.g. at 85 degrees). It will also be recognized that, depending on the nature of the surface texture of an area, and/or the nature of any microstructure 200 that is superimposed on that particular area, the gloss of an area/region might depend on the orientation of the incident light relative to any orientation of the texture and/or microstructure (that is, relative to the x-y axes of the substrate, as depicted in FIGS. 1-3). In such circumstances, an average gloss may be obtained that is derived from gloss measurements taken at various orientations with respect to the x-y axes of the substrate.

The surface texture of an area 110 and an area 130 may be characterized by profilometry, as will be understood by the ordinary artisan. Such profilometry can be done along several orientations relative to the x-y axes of substrate 1, if the surface texture has an orientation dependence. (Such profilometry measurements of this surface texture may omit any contribution of physical microstructure 200). Results of such profilometric characterization are often cast in terms of surface roughness, e.g. Rₐ, which is a well-recognized average surface roughness parameter. In various embodiments, high-gloss areas 110 may comprise an Rₐ of less than 0.2 μm, 0.1 μm, 0.05 μm, or 0.02 μm. In various embodiments, low-gloss areas 130 may comprise an Rₐ of greater than 0.2 μm, 0.4 μm, 0.8 μm, 2, μm, or 4 microns. (It will be appreciated that the above-presented definitions of low gloss and high gloss merely require that areas 130 comprise a lower gloss than areas 110, without requiring any absolute value of the gloss, or of the Rₐ, be exhibited by the respective areas. Thus, it should not be inferred that an Rₐ of e.g. 0.2 μm is a defining boundary between “high” and “low” gloss. Rather, the surface roughness Rₐ is merely an additional parameter that may be used to characterize the high and low gloss areas.

Further details of substrate 1 may be discussed with reference to FIG. 3, which shows a plan view of first major surface 101 of substrate 1, including first, high-gloss areas 110 (which are indicated by a lack of any surface shading) and second, areas 130 in which a low gloss (i.e., lower than that of areas 110) is imparted by a molded textured surface (which textured surface is indicated by the surface stippling in FIG. 3).

First, high-gloss areas 110, and second, low-gloss areas 130, may be provided on first major surface 101 of substrate 1 in any desired pattern. In this context, the term area encompasses a surface portion of any size, including microscopic areas (e.g., those that are too small to be seen by the unaided human eye, e.g. down to a few square microns in size). In some embodiments, areas 110 of high gloss may be arranged so as to collectively comprise macroscopic regions 111 (i.e., areas of greater than about 2 mm²) with high gloss, whether areas 110 that form regions 111 are in contiguous arrangement, or whether they are separated from each other e.g. by some portion of areas 130 and/or by microstructure 200. Similarly, areas 130 of low gloss may be arranged so as to collectively comprise macroscopic regions 131 with low gloss (e.g., with a matte finish), whether areas 130 are in contiguous arrangement, or whether they are separated from each other e.g. by some portion of areas 110 and/or by microstructures 200.

In various embodiments, low-gloss macroscopic regions 131 with molded textured surfaces may exhibit a gloss of less than about 40, 20, 10, 5, or 2 gloss units. In some embodiments low-gloss areas macroscopic areas 131 may exhibit a matte finish (appearance), as will be recognizable to the ordinary artisan. In various embodiments, high-gloss macroscopic regions 111 may exhibit a gloss of at least 20, 40, 60, or 80 gloss units. In various embodiments, low-gloss macroscopic regions 131 can exhibit a gloss that is lower than that of high-gloss macroscopic regions 111, by at least 5, 10, 20, 40, or 60 gloss units (e.g., irrespective of the absolute value of the gloss units of the respective macroscopic regions), so as to provide sufficient contrast in gloss that e.g. a reflected-light indicia may be observed. Any suitable arrangement of high and low gloss areas may be used. It will be appreciated, for example, that a high-gloss macroscopic region 111 may comprise some number of low-gloss (e.g., microscopic) areas 130; however, as long as the macroscopic region 111 is dominated by high-gloss areas 110 so as to exhibit macroscopic high gloss, region 111 is still considered to be a high-gloss region. Similar considerations apply with regard to low-gloss macroscopic regions 131.

In some embodiments, such macroscopic regions 111 and 131 may be arranged in combination to collectively provide any suitable decorative pattern. Such a decorative pattern might comprise a representation of an object or scene, an abstract pattern, a random pattern, a regular pattern, and so on. (A checkerboard pattern is depicted in the exemplary embodiment of FIG. 3).

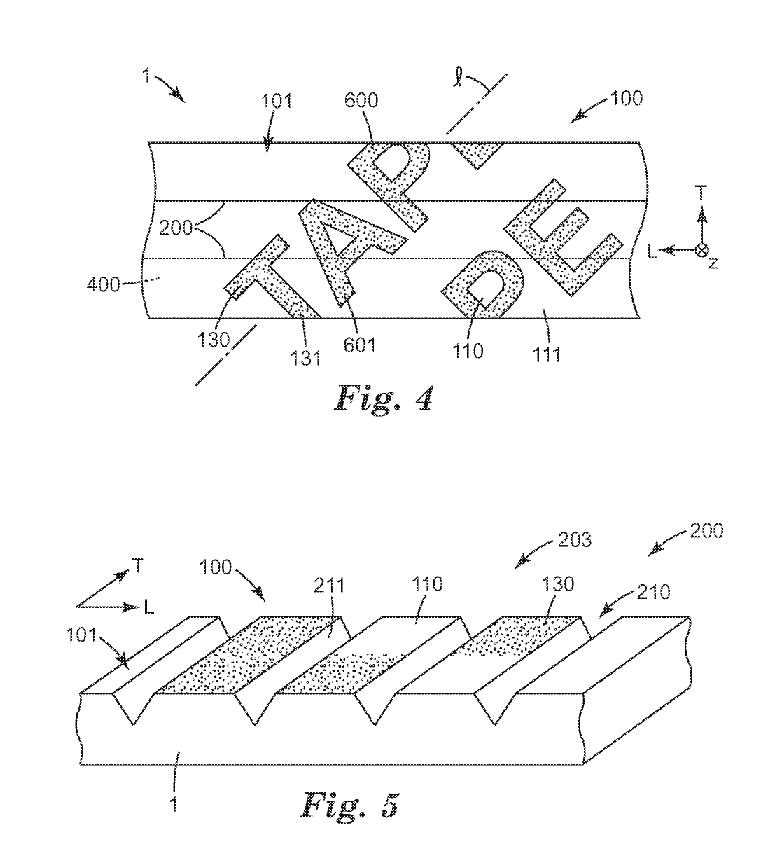

In some embodiments, high-gloss areas/regions and low-gloss areas/regions may be arranged in combination to collectively provide at least one informational indicia 600 as shown in exemplary manner FIG. 4. Such an informational indicia can comprise e.g. a logo, trade designation, or the like (whether such indicia is in the form of text, or a symbol or picture, or a mixture of both). It will be appreciated that these features may allow substrate 1 to display a non-printed, informational indicia (akin to e.g. a watermark) that is observable at least when visible light is impinged onto, and reflected from, the first major side of substrate 1, and that is obtained without having to deposit any pigment, ink, label, etc. onto substrate 1. In some embodiments, an informational indicia may comprise a text string (whether alone, or in combination with other visual elements), as exemplified by text string 601 of FIG. 4. In further embodiments, substrate 1 may comprise a longitudinal axis “L” and the text string may comprise a long axis “l” as shown in FIG. 4. In specific embodiments, the long axis of the text string may be oriented at an angle of from about 20 degrees to about 70 degrees with respect to the longitudinal axis of substrate 1, as shown in FIG. 4. In further embodiments, the long axis of the text string may be oriented at from about 35 degrees to about 60 degrees with respect to the longitudinal axis of substrate 1.

In any of these embodiments, low gloss regions 131 may individually or collectively provide a background, with certain high gloss regions 111 individually or collectively providing a specific observable feature (e.g., an image or a letter) thereupon. Or, the reverse may be the case. Or, combinations of both approaches may be employed.

Any suitable molded features can be used to lower the gloss of area 130 relative to area 110. A feature, in this context, can be anything that represents a departure or deviation (along the z-axis of substrate 1) from a flat planar surface, which deviation is on a scale suitable to scatter visible light and thus to reduce specular reflection from the surface. Such features may be randomly provided, or may comprise a predetermined pattern. Such features of an area 130 may comprise e.g. those that protrude outward relative to the average level of major surface 101 (along an axis (the z-axis) normal to the major plane of substrate 1) within the area 130 (e.g., as measured and averaged over the area 130, and not including any contribution from physical microstructure 200). Such features may also comprise those that are recessed inward relative to this average level. Such protruding features may be characterized e.g. as protrusions, nodules, hillocks, pyramids, stems, posts, bumps, ridges, etc.; such recessed features may be characterized e.g. as depressions, holes, pits, fissures, furrows, crevices, divots, etc. A textured surface may possess a combination of protruding and recessed features (e.g., furrows and ridges, protruding and recessed pyramids, nodules with pits therebetween, etc.).

It will be appreciated that the presence of such features in a size range adequate to scatter light (e.g., in the range of from about 0.2 microns to about thirty microns) may provide such functionality. Such features may comprise e.g. surfaces that may be locally planar (i.e., over the range of a few microns or less), but that have such a small size and/or are arranged so as to collectively provide a low gloss. Examples of substrates of this general type are described e.g. in U.S. Patent Application Publication 2010/0302479. Or, such features may comprise e.g. surfaces that are non-planar (curved) over the dimensional range of a few microns or less (e.g., that are in the form of nodules or the like). Examples of substrates of this general type are described e.g. in U.S. Patent Application Publication 2007/0014997. Substrates with features of both types, and/or features with any combination of locally planar and/or locally arcuate surfaces, may be used. (It is noted that with surface texture present, the average z-axis level of major surface 101 in the area neighboring a physical microstructure may be used as a reference datum plane for purposes of characterizing the height of the physical microstructure.)

While first, high-gloss areas 110 are not precluded from having some molded surface texture, such areas will have less surface texture than second areas 130 so that they exhibit a higher gloss than that exhibited by areas 130, as discussed above. In some embodiments, high-gloss areas 110 may lack surface texture, e.g. they may be flat surfaces (e.g., on a dimensional scale of 0.2 μm or more). In some embodiments such surfaces may be e.g. optically smooth surfaces (e.g., such as obtained during the forming of substrate 1 by molding a molten polymeric material against a very smooth tooling surface such as a polished metal roll or the like).

Control of gloss has often been employed with highly light-transmissive substrates, e.g. in order to minimize the degree to which specular reflection from the substrate might interfere with light that is transmitted through the substrate. Such issues often arise e.g. in displays and similar applications in which the interplay between transmitted light and reflected light is important. In contrast, the present application is concerned with the control of gloss e.g. for the purpose of enhancing the appearance of a substrate that comprises a physical microstructure. Such substrates, which may find use in e.g. tapes and the like, may often be poorly light transmissive (e.g., translucent, or even opaque). Accordingly, heretofore it has not been known to have been found useful to manipulate the gloss of such substrates in the manner disclosed herein. However, the inventors have now found that particularly in certain applications (e.g., masking tapes, which have historically employed paper substrates with a matte appearance), end-users may notice a relatively high-gloss substrate (i.e., such as a plastic film made without bringing to bear any of the methods disclosed herein to impart lower gloss to the substrate) to have a shiny appearance that may be perceived by some users as somewhat “plasticky” and thus less desirable. Accordingly, the providing of areas with a low gloss (e.g., a matte finish) as disclosed herein may be advantageous. Furthermore, the providing of areas of high and low gloss to collectively form a pattern, e.g. a decorative pattern, can further enhance the attractiveness of the substrate. Still further, such contrasting-gloss patterns can be configured to provide an informational indicia which is formed in the act of producing the substrate, such that no post-formation printing, embossing, or labeling operation is needed to provide the indicia. All of these can provide significant advantages and can also render it difficult to produce a counterfeit product containing the substrate. And, all this can be done without the contrasting-gloss patterns interfering with the performance of the microstructure(s) superimposed thereupon, and vice versa.

Microstructure 200 can comprise any desired physical microstructure. By physical microstructure is meant a microstructure that serves, in ordinary use of substrate 1, to provide a physical effect on matter (such as e.g. the manipulation of a fluid, and/or the propagation of a tear through substrate 1, and others as discussed below). As such, microstructures which in ordinary use achieve an effect that is optical in nature (that is, which manipulate electromagnetic radiation, e.g. visible light, for a desired optical effect) are specifically excluded from this definition. (The above definition is notwithstanding the fact that any microstructure, including a physical microstructure, may of course exhibit some incidental optical effect, if only by virtue of being visible under some conditions).

The concept of a physical microstructure encompasses both structures that protrude above major surface 101 of substrate 1 (as exemplified by protrusion 201 of FIG. 2); and, “structures” (i.e., features) that are recessed below major surface 101 of substrate 1 (as exemplified by recess 202 of FIG. 3). Combinations of the two can of course be present. By a microstructure is further meant that the structure is a predetermined, molded structure (e.g., as obtained by molding a polymeric thermoplastic resin against a tooling surface that comprises the negative of the microstructure desired to be provided on first major side 100 of substrate 1) with dimensions ranging from about 5 to about 400 microns in at least two orthogonal directions. One of these orthogonal directions may often be normal to the plane of backing 1 (that is, along the z-axis) thus this dimension can comprise e.g. a protrusion height or a recess depth. By way of a specific example, for if a recessed microstructure comprises e.g. an elongate groove, such a direction is the groove depth. Often, the lateral width of such a groove (lateral meaning in a direction across the width of the groove) may comprise the second, orthogonal direction. Thus, if the depth of the groove and the lateral width of the groove are both between about 5 and about 400 microns at any location along the length of the groove, the groove is by definition a microstructured feature irrespective of the fact that it may have an extremely long length. The same considerations apply to protruding microstructures that are e.g. in the form of elongated ribs, with regard to the height, width, and length of the ribs.

Surfaces of the at least one physical microstructure 200 may, in various embodiments, comprise texture (e.g., of similar or the same type comprised by low-gloss areas 130); or, such surfaces may be flat, e.g. optically smooth, as desired. It will be recognized that physical microstructure 200 may exert at least some slight effect on the gloss of macroscopic regions of substrate 1, as discussed above. However, physical microstructure 200 may be omitted when characterizing properties of areas 110 and 130 such as the heights of surface features of these areas relative to the average level of the surface in that area, surface roughness Rₐ, and so on. (In this regard, it is noted that the height or depth of any particular feature of an area with regard to its ability to provide gloss-lowering texture, should be measured relative to the average level of the major surface in that area, which issue might come into play e.g. in the case that areas 130 are vertically offset (along the z-axis of substrate 1) with respect to areas 110).

As mentioned, physical microstructure 200 can have the intended function of providing any desired physical effect on matter. In various embodiments, physical microstructure 200 thus might serve to abrade an item (that is, to provide a so-called structured abrasive), to establish an electrically-conductive pathway to an item (that is, to provide a so-called z-axis conductor), to establish a thermally-conductive pathway to an item, to filter solid particles, to mechanically attach to an item (that is, to provide a mechanical fastener such as a mating surface fastener or a hook component of a hook and loop fastener), to adhesively attach to an item (that is, to provide a so-called structured adhesive), and so on.

In some embodiments, physical microstructure might serve to promote and/or propagate a tear along substrate 1 (e.g., to allow one portion of substrate 1 to be separated from another portion of substrate 1). In some embodiments, physical microstructure 200 may thus comprise a microstructured hand-tear pattern, which may render substrate 1 more easily able to be torn (e.g., across a transverse width of substrate 1, generally along transverse axis “T” as depicted in FIG. 5) so as to render substrate 1 useful as a backing for e.g. a hand-tearable tape. An exemplary hand-tear pattern 203 is shown in FIG. 5, in which physical microstructure 200/hand-tear pattern 203 comprises a multiplicity of lines of weakness 210. Each individual line of weakness 210 may be a continuous line of weakness that is provided by a recess in first major side 100 of substrate 1, or may be a discontinuous line of weakness that is collectively provided by a multiplicity of recesses in first major side 100 of substrate 1. By a recess is meant a feature at least some of whose surface(s) are recessed below first major surface 101 of first major side 100 of substrate 1 (i.e., inward toward the interior of substrate 1), so as to comprise an open-ended, outward-facing cavity. In some embodiments, a recess that provides a line of weakness 210 may comprise an elongate groove 211 e.g. that may extend continuously across a transverse width of substrate 1 (i.e. from one minor edge of substrate 1 to another minor edge of substrate 1). In some embodiments, lines of weakness 210 may be discontinuous by way of being collectively comprised of recesses that are spaced across the transverse width of first side 100. In various embodiments, lines of weakness 210 may be spaced along a longitudinal extent of substrate 1, and in further embodiments each line of weakness may be oriented within plus or minus 45, 20, 10, or 5 degrees from the transverse axis T of substrate 1.

In some embodiments, physical microstructure 200 might serve to manipulate a fluid (whether liquid or gas). In various embodiments of this type, physical microstructure 200 might serve to promote the wicking of a liquid, to filter solid particles from a liquid or gas, to heat or cool a liquid or gas, to deliver a therapeutic drug, to obtain a biological sample, to alter the motion of a gas so as to alter its acoustic properties, and so on. In particular embodiments, physical microstructure 200 may comprise a liquid-retention microstructure (e.g., a paint-retention microstructure) that serves to capture and retain a liquid so as to retard or reduce the ability of the liquid to flow along major side 100 of substrate 1. Such a property may render substrate 1 useful as a backing for e.g. masking tape. A fluid-manipulation microstructure of this type may

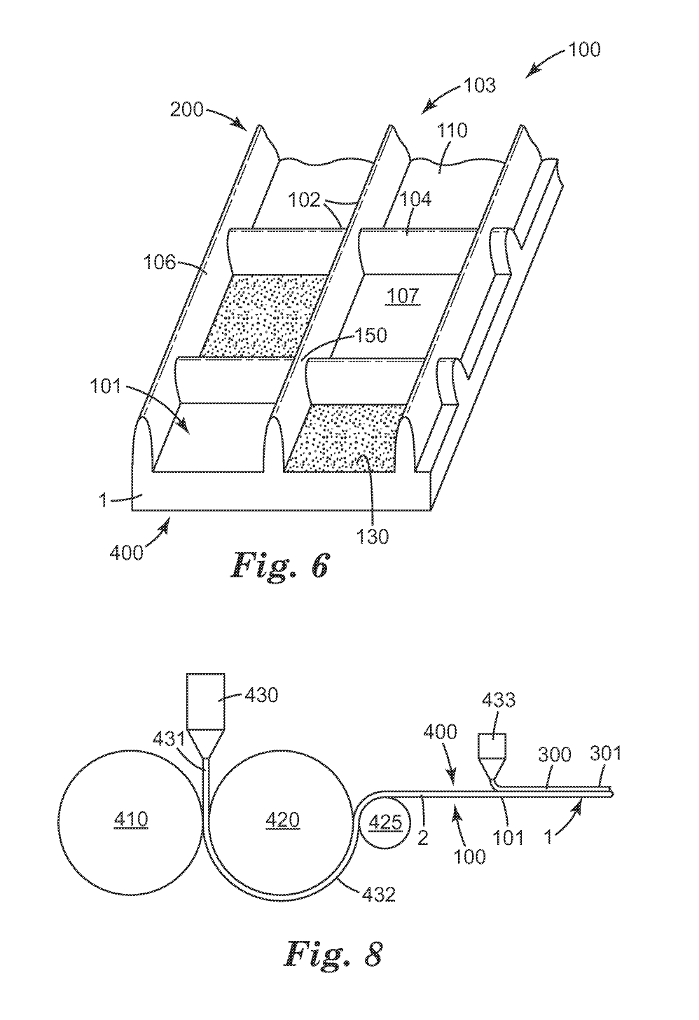

comprise a multiplicity of microreceptacles 107 that are defined (i.e., bounded, whether continuously or discontinuously) by a physical microstructure 200 that is in the form of a microstructured liquid-retention pattern 103, which comprises microstructured partitions 102 (e.g., as shown in exemplary manner in FIG. 6). In some embodiments, microstructured partitions 102 may comprise a multiplicity of first elongate partitions 104 that may not physically intersect with each other, and a multiplicity of second elongate partitions 106 that may not physically intersect with each other. At least some of first partitions 104 may intersect with at least some of second partitions 106 at intersections 150 so as to define microreceptacles 107 thereby. (In various embodiments partitions 104 and/or 106 may be continuous or discontinuous; thus, in embodiments comprising discontinuous partitions, intersections 150 may comprise points in space at which long axes of partitions 104 and 106 intersect, rather than being actual physical intersections of partitions 104 and 106.) In various embodiments, a microstructured partition 102 may comprise a height, somewhere along its length, ranging from about 10 microns to about 200 microns. In further embodiments, a microstructured partition 102 may comprise a height, somewhere along its length, ranging from about 20 microns to about 80 microns. In still further embodiments, a microstructured partition 102 may comprise a height, somewhere along its length, ranging from about 30 microns to about 50 microns. In some embodiments, elongated partitions 104 and 106 may comprise elongate ribs (as in the exemplary design of FIG. 6).

Further details of microstructured hand-tear patterns and of microstructured liquid-retention patterns are found in U.S. patent application Ser. No. 13/042,536, filed Mar. 8, 2011, entitled Microstructured Tape, which is incorporated by reference in its entirety herein.

As mentioned above, in some embodiments substrate 1 may comprise multiple physical microstructures 200; e.g., so as to provide more than one physical effect on matter. Any such combination of e.g. the above-described exemplary physical microstructures is encompassed within the disclosures herein.

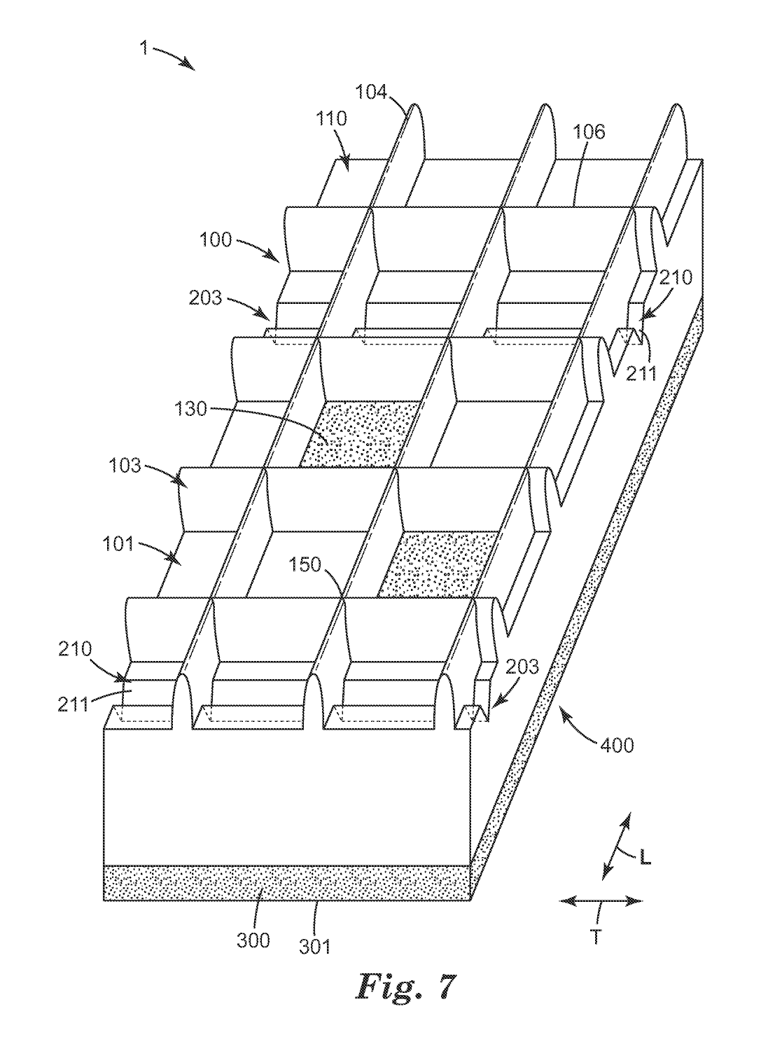

In particular embodiments, the at least one physical microstructure 200 of first major side 100 of substrate 1 may comprise both a liquid-retention pattern 103 and a hand-tear pattern 203, which patterns may be coextensive and intersecting. By coextensive is meant that the two patterns are overlapping; that is, they are both present in at least some macroscopic areas (i.e., areas of greater than about 2 mm²) of first major side 100. By intersecting is meant that long axes of at least some partitions of the liquid-retention pattern intersect long axes of at least some lines of weakness of the hand tear pattern, at some location within the elongate lengths of the partitions and the lines of weakness. Microstructures of each pattern may, but do not have to, physically intersect with microstructures of the other pattern. A substrate 1 comprising at least one physical microstructure in the form of a microstructured hand-tear pattern and a microstructured liquid-retention pattern, which patterns are coextensive and intersecting, is shown in exemplary manner in FIG. 7. The various structures and features of each pattern may comprise attributes and properties as described above.

The use of coextensive, intersecting physical microstructures, e.g. in combination with areas of controlled gloss, is described in more detail in U.S. Provisional Patent Application No. ______, filed the same day as the present application, and entitled Microstructured Tape Comprising Coextensive, Intersecting Paint-Retention and Hand-Tear Patterns, which application is incorporated by reference herein in its entirety.

Substrate 1 and major surface 101 thereof, including first areas 110 and second areas 130, and physical microstructure 200, are defined herein as constituting a monolithic plastic unit made of a monolithic plastic material. By this is meant major surface 101 and first areas 110 and second areas 130 thereof (including textured features of second areas 130), and physical microstructure 200 (whether microstructure 200 comprises protruding features, recessed features, or both) are integrally connected to substrate 1 and were formed by being molded therewith. Such a monolithic plastic unit may be conveniently formed e.g. by providing a polymeric thermoplastic film or a molten polymeric thermoplastic extrudate and molding the first major surface so as to form substrate 1, first and second areas 110 and 130 of major surface 101 thereof, and physical microstructure 200, all at the same time, as an integral unit. In various embodiments, the overall thickness of substrate 1, from second major surface 401 of second major side 400, to the outermost portion of physical microstructure 200, may be at least about 25 microns, at least about 50 microns, at least about 60 microns, or at least about 70 microns. In further embodiments, the overall thickness of substrate 1 may be at most about 1000 microns, 500 microns, 250 microns, 150 microns, 100 microns, or 50 microns. In some embodiments, the material that comprises substrate 1 and second major surface 401 thereof, the material that comprises texturing features of areas 130, and the material that comprises physical microstructure 200, are all of the same composition.

The plastic material of substrate 1 may be e.g. a moldable polymeric thermoplastic material and by definition is not a foamed or porous material. In some embodiments, the plastic material may be noncellulosic, meaning that it contains less than about 5 wt. % cellulosic material (e.g., cellulose, paper, regenerated cellulose, wood fibers, wood flour, etc., with, in this context, cellulose acetate and the like not considered to be cellulosic materials). In particular embodiments, the plastic material may be melt-processable, e.g. extrudable. The moldable polymeric thermoplastic material may be made from, or include, any of a variety of materials. Homopolymers, copolymers and blends of polymers may be useful, and may contain a variety of additives. Suitable thermoplastic polymers may include, for example, polyolefins such as polypropylene or polyethylene; polystyrene, polycarbonate, polymethyl methacrylate, ethylene vinyl acetate copolymers, acrylate-modified ethylene vinyl acetate polymers, ethylene acrylic acid copolymers, nylon, polyvinylchloride, and engineering polymers such as polyketones or polymethylpentanes. Mixtures of such polymers may also be used.

In some embodiments, the plastic material may be a polyolefinic material, defined herein as being any homopolymer, copolymer, blend, etc., of any olefinic polymers (e.g., polyethylenes, polypropylenes, and so on). In some embodiments, the polyolefinic material may contain at least about 90 wt. %, at least about 95 wt. %, or at least about 98 wt. % of polyethylenes, not counting the weight of any mineral fillers that may be present. (In this context, by polyethylenes are meant polymers comprised of at least 95% ethylene units. In further embodiments, the polyethylenes are ethylene homopolymers.) In some embodiments, the polyolefinic material may consist essentially of ethylene homopolymers, noting that this requirement (in addition to not including the weight of any mineral fillers) does not preclude the presence of processing aids, plasticizers, antioxidants, colorants, pigments, and the like, at least some of which may contain some small level of non-polyethylene polymers.

In various embodiments, substrate 1 may be comprised of at least 20, 40, 60, 80, 90, 95, or 99 weight % of a semicrystalline polymer, which semicrystalline polymer may have a percent crystallinity (as measured by e.g. differential scanning calorimetry) of at least about 20, 40, 60, or 80%. It will be appreciated that substrates such as e.g. those comprising a significant amount of semicrystalline polymer may exhibit a high degree of light scattering. Thus in various embodiments, substrate 1 may exhibit a haze (as measured e.g. in similar manner to the procedures outlined in ASTM Test Method D-1033-11e1), of at least about 20, 40, 80, or 95% (noting that the haze may be at least slightly affected by surface texturing thus the measured haze of a substrate 1 may represent contributions from both areas 110 and 130).

In various embodiments, substrate 1 may include one or more opacifying agents that reduce the light transmission through substrate 1. Such agents might include opacifying fillers (e g mineral fillers such as calcium carbonate, titanium dioxide or kaolin, fillers such as carbon black, etc.). Substrate 1 may also include an effective amount of one or more coloring agents (e.g., inks, tints, pigments, etc.) that impart a readily discernible color or hue to the substrate (that is, a distinct color other than white). It will be recognized that many such coloring agents may also serve an opacifying function, depending e.g. on their concentration. In various embodiments, substrate 1 may comprise a visible light transmission of less than about 40%, 20%, 10%, 5%, 2%, 1%, 0.5%, or 0.1%, e.g. as tested in similar manner to the procedures described in ASTM Test Method D-1033-11e1, as specified in 2011. (Such light transmission may result from reduction in light transmission due to e.g. the effects of light-scattering domains of a semicrystalline polymer, the effects of opacifying agents, or both).

Shown in FIG. 8 is an exemplary apparatus and process 400 for making substrate 1 and products therefrom. Extruder 430 can be used to extrude molten polymeric thermoplastic extrudate 431, one major surface of which then contacts tooling roll 410, which roll bears on its surface the negative of the desired features to be imparted to first major side 100 of substrate 1. Additionally the opposing major surface of extrudate 431 contacts backing roll 420, which roll may have no particular texturing features and/or microstructure (unless it is desired to impart particular texturing features and/or a particular microstructure to second major side 400 of substrate 1). For example, the surface of backing roll 420 may comprise e.g. a conventional matte-finish surface or a conventional polished surface, whichever may be more desirable (e.g., so as to enhance the coatability and adherability of a pressure-sensitive adhesive onto the thus-formed surface of substrate 1). Conveniently, the contacting of the extrudate with the two molding surfaces may be done essentially simultaneously, e.g. by impinging molten extrudate 431 into a narrow gap (nip) in between rolls 410 and 420. Those of ordinary skill will appreciate that, rather than rolls 410 and/or 420, such surfaces as may be provided by belts, platens, and the like, can be used if desired. A tooling surface may be metal (e.g., in the form of a metal roll as in the exemplary configuration of FIG. 8), or may comprise softer materials, e.g. a polymeric belt, sleeve or coating disposed upon a metal backing roll. Such tooling surfaces, with the negative of the desired features thereon, may be obtained e.g. by engraving, knurling, diamond turning, laser ablation, electroplating or electroless deposition, or the like, as will be familiar to those of skill in the art.

In further detail, in order to provide (gloss-lowering) molded surface texturing features on areas 130 of first major surface 101 of first major side 100 of substrate 1, portions of the major surface of the tooling can be processed so as to comprise the negative of such texture. This may be performed by any suitable methods (e.g., engraving, knurling, electroplating, electroless deposition, chemical etching, laser ablation, sandblasting, etc.). Or, a machining tool coupled to a fast tool servo may be used to machine the selected major surface areas in such manner as to produce a chaotic or randomly textured structure in desired areas, e.g. as described in Examples 8 and 9 of U.S. Patent Application Publication 2008/0049341.

Molten extrudate 432 that has been contacted with a tooling surface so as to impart the above discussed features and structures thereon, can be solidified so as to form substrate 1. It may be convenient that the molded extrudate be held in contact with a backing roll, e.g. by following a path around a significant portion of backing roll 420 as shown in exemplary manner in FIG. 8, to allow such solidification. (Or, if it is desired that the molten extrudate be held in contact with the tooling surface as long as possible, the molded extrudate may follow a path around a significant portion of tooling roll 410). If desired, a takeoff roll 425 may be provided to assist in the handling of the molded, solidified substrate 1 upon its removal from a tooling roll or backing roll. Substrate 1 can then be used as is, for any purpose. Optionally, a pressure-sensitive adhesive 300 can be disposed e.g. on second major side 400 of substrate 1 (to form a product of the type shown in the exemplary illustration of FIG. 7, e.g. an adhesive tape), e.g. by using coater 433. The deposition of pressure-sensitive adhesive 300 can be in-line in the same process as the molding, as in the exemplary configuration of FIG. 8. Or, it can be done off-line, in a separate process.

Any suitable pressure-sensitive adhesive material or composition can be used in pressure-sensitive adhesive 300. Pressure-sensitive adhesives are normally tacky at room temperature and can be adhered to a surface by application of, at most, light finger pressure and thus may be distinguished from other types of adhesives that are not pressure-sensitive. A general description of useful pressure-sensitive adhesives may be found in Encyclopedia of Polymer Science and Engineering, Vol. 13, Wiley-Interscience Publishers (New York, 1988). Additional description of useful pressure-sensitive adhesives may be found in Encyclopedia of Polymer Science and Technology, Vol. 1, Interscience Publishers (New York, 1964). It may be convenient that the adhesive material be chosen so as to provide good adhesion to a surface, while also being removable under moderate force without leaving a residue, e.g. a visible residue.

Whether made by a process of the general type shown in FIG. 8 or by any other suitable process, a thus-formed adhesive tape may be conveniently provided e.g. in the form of a roll. In some embodiments, such an adhesive tape and a roll thereof, may not include any kind of release liner (e.g., a paper or plastic film bearing a release surface, whether supplied by the film itself or by a low-energy coating thereupon, such release liners being well known in the adhesive arts). That is, in such embodiments the roll is a self-wound roll meaning that it is wound directly upon itself with outward surface 301 of pressure-sensitive adhesive 300 being in releasable contact with the outwardmost surfaces of physical microstructure 200 and/or with major surface 101 of first major side 100 of substrate 1. Such a tape may be used e.g. as a masking tape, as will be readily appreciated by the ordinary artisan. It will be appreciated that in such case as substrate 1 is formed into a tape, the above methods allow a visually observable pattern, such as an informational indicial, to be provided on the outward side of the tape (that is, the side that is visible when the tape is in the form of a roll, and after it is adhesively attached to a surface). Such indicia or the like can thus be provided without the need to deposit ink, pigment, labels, or the like onto the tape and without unacceptably interfering with the functioning of physical microstructure 200.

Any coating, treatment, etc. may be performed on, or applied to, first major side 100 of substrate 1, as long as it does not unacceptably interfere with the functioning of physical microstructure 200, and does not unacceptably change the gloss of areas 130 or 110. Such treatments might include e.g. a metal coating, a priming layer, a treatment (e.g., corona, plasma, etc.) or the like. However, in some embodiments, no coating, treatment, or any kind of additional layer is present on major side 100 of substrate 1. In some embodiments, substrate 1 does not comprise any kind of optical microstructure within, and/or on either major side thereof (that is, physical microstructure(s) 200 is/are the only microstructures present on substrate 1, irrespective of the presence of surface texture in areas 130). In some embodiments, substrate 1 does not comprise any kind of matte-imparting particles within the interior of substrate 1. In various embodiments, substrate 1 does not comprise a physical microstructure that comprises an adhesive attaching function, a non-adhesive attaching function, an abrasive function, or a liquid-wicking function.

### LIST OF EXEMPLARY EMBODIMENTS

### Embodiment 1

A polymeric substrate comprising a first major side with a first major surface comprising: first, high-gloss areas; and, second, low-gloss areas that comprise a molded textured surface that cause the second, low-gloss areas to have a gloss that is lower than the gloss of the first, high-gloss areas, the first and second areas being provided on the first major surface in a predetermined pattern; and, wherein the first major side of the substrate further comprises at least one physical microstructure that is superimposed on the first, high-gloss areas and on the second, low-gloss areas.

### Embodiment 2

The substrate of embodiment 1 wherein the second, low-gloss areas comprise an 85 degree gloss that is less than about 10 gloss units.

### Embodiment 3

The substrate of embodiment 1 wherein the second, low-gloss areas comprise an 85 degree gloss that is less than about 20 gloss units.

### Embodiment 4

The substrate of embodiment 1 wherein the second, low-gloss areas comprise an 85 degree gloss that is less than about 5 gloss units.

### Embodiment 5

The substrate of any of embodiments 1-4 wherein the first, high-gloss areas comprise an 85 degree gloss that is greater than about 40 gloss units.

### Embodiment 6

The substrate of any of embodiments 1-4 wherein the first, high-gloss areas comprise an 85 degree gloss that is greater than about 30 gloss units.

### Embodiment 7

The substrate of any of embodiments 1-4 wherein the first, high-gloss areas comprise an 85 degree gloss that is greater than about 60 gloss units.

### Embodiment 8

The substrate of any of embodiments 1-7 wherein the second, low-gloss areas comprise an 85 degree gloss that is lower than the gloss of the first, high-gloss areas by at least about 10 gloss units.

### Embodiment 9

The substrate of any of embodiments 1-7 wherein the second, low-gloss areas comprise an 85 degree gloss that is lower than the gloss of the first, high-gloss areas by at least about 20 gloss units.

### Embodiment 10

The substrate of any of embodiments 1-7 wherein the second, low-gloss areas comprise an 85 degree gloss that is lower than the gloss of the first, high-gloss areas by at least about 40 gloss units.

### Embodiment 11

The substrate of any of embodiments 1-10 wherein the first, high-gloss areas comprise a surface roughness Rₐ of less than 0.05 microns.

### Embodiment 12

The substrate of any of embodiments 1-11 wherein the second, low-gloss areas comprise a surface roughness Rₐ of greater than 0.8 microns.

### Embodiment 13

The substrate of any of embodiments 1-12 wherein the first, high-gloss areas collectively form first, high-gloss macroscopic regions on the first side of the substrate, and wherein the second, low-gloss areas collectively form second, low-gloss macroscopic regions on the first side of the substrate; and, wherein the first, high-gloss macroscopic regions and the second, low-gloss macroscopic regions combine to collectively form a visually observable pattern when visible light is impinged upon the first major side of the substrate and is reflected therefrom.

### Embodiment 14

The substrate of embodiment 13 wherein the first, high-gloss macroscopic regions and the second, low-gloss macroscopic regions combine to collectively form an informational indicia that is observable when visible light is impinged upon the first major side of the substrate and is reflected therefrom.

### Embodiment 15

The substrate of embodiment 14 wherein the indicia comprises a logo.

### Embodiment 16

The substrate of embodiment 14 wherein the substrate has a longitudinal axis and wherein the indicia comprises at least one text string with a long axis that is oriented at an angle of from about 20 to about 70 degrees with respect to the longitudinal axis of the substrate.

### Embodiment 17

The substrate of embodiment 13 wherein the first, high-gloss macroscopic regions and the second, low-gloss macroscopic regions combine to collectively form a decorative pattern that is observable when visible light is impinged upon the first major side of the substrate and is reflected therefrom.

### Embodiment 18

The substrate of any of embodiments 1-17 wherein the substrate comprises a visible light transmission of less than about 10%.

### Embodiment 19

The substrate of any of embodiments 1-17 wherein the substrate is chosen from the group consisting of substrates comprising a visible light transmission of less than about 4, 2, 1, and 0.5%.

### Embodiment 20

The substrate of any of embodiments 1-19 wherein the polymeric material of the polymeric substrate contains at least 2 wt % of an opacifying agent.

### Embodiment 21

The substrate of any of embodiments 1-20 wherein the polymeric material of the polymeric substrate comprises an effective amount of at least one coloring agent such that, when visible light is impinged upon the first major side of the substrate and is reflected therefrom, the substrate displays a readily discernible non-white color.

### Embodiment 22

The substrate of any of embodiments 1-21 wherein the polymeric material of the substrate is a semicrystalline thermoplastic polymer.

### Embodiment 23

The substrate of any of embodiments 1-22 wherein the substrate is a tape backing.

### Embodiment 24

The substrate of embodiment 23 further comprising a pressure sensitive adhesive disposed on the second major side of the tape backing.

### Embodiment 25

The substrate of any of embodiments 1-24 wherein the at least one physical microstructure is a microstructured hand-tear pattern.

### Embodiment 26

The substrate of any of embodiments 1-24 wherein the at least one physical microstructure is a microstructured liquid-retention pattern.

### Embodiment 27

The substrate of any of embodiments 1-24 wherein the least one physical microstructure comprises a microstructured hand-tear pattern and a microstructured liquid-retention pattern, wherein the microstructured hand-tear pattern and the microstructured liquid-retention pattern are coextensive and intersecting.

### Embodiment 28

A method of making a polymeric substrate a first major side with first, high-gloss areas and with second, molded textured low-gloss areas and with at least one physical microstructure that is superimposed on the first and second areas, the method comprising: contacting a first major surface of a molten polymeric extrudate with a first tooling surface that comprises a negative of the first and second areas and of the physical microstructure, so that the first major surface of the extrudate is molded against the first tooling surface so as to form a polymeric substrate a first major side with first, high-gloss areas and with second, molded textured low-gloss areas and with at least one physical microstructure that is superimposed on the first and second areas.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather extends at least to the structures described by the language of the claims, and the equivalents of those structures. To the extent that there is a conflict or discrepancy between this specification and the disclosure in any document incorporated by reference herein, this specification will control.

What is claimed is:

1. A polymeric substrate comprising a first major side with a first major surface comprising:
first, high-gloss areas; and,
second, low-gloss areas that comprise a molded textured surface that cause the second, low-gloss areas to have a gloss that is lower than the gloss of the first, high-gloss areas,
the first and second areas being provided on the first major surface in a predetermined pattern;
and,
wherein the first major side of the substrate further comprises at least one physical microstructure that is superimposed on the first, high-gloss areas and on the second, low-gloss areas.

2. The substrate of claim 1 wherein the second, low-gloss areas comprise an 85 degree gloss that is less than about 10 gloss units.

3. The substrate of claim 1 wherein the first, high-gloss areas comprise an 85 degree gloss that is greater than about 40 gloss units.

4. The substrate of claim 1 wherein the second, low-gloss areas comprise an 85 degree gloss that is lower than the gloss of the first, high-gloss areas by at least about 10 gloss units.

5. The substrate of claim 1 wherein the first, high-gloss areas comprise a surface roughness Rₐ of less than 0.05 microns.

6. The substrate of claim 1 wherein the second, low-gloss areas comprise a surface roughness Rₐ of greater than 0.8 microns.

7. The substrate of claim 1 wherein the first, high-gloss areas collectively form first, high-gloss macroscopic regions on the first side of the substrate, and wherein the second, low-gloss areas collectively form second, low-gloss macroscopic regions on the first side of the substrate;
and,
wherein the first, high-gloss macroscopic regions and the second, low-gloss macroscopic regions combine to collectively form a visually observable pattern when visible light is impinged upon the first major side of the substrate and is reflected therefrom.

8. The substrate of claim 7 wherein the first, high-gloss macroscopic regions and the second, low-gloss macroscopic regions combine to collectively form an informational indicia that is observable when visible light is impinged upon the first major side of the substrate and is reflected therefrom.

9. The substrate of claim 8 wherein the indicia comprises a logo.

10. The substrate of claim 9 wherein the substrate has a longitudinal axis and wherein the indicia comprises at least one text string with a long axis that is oriented at an angle of from about 20 to about 70 degrees with respect to the longitudinal axis of the substrate.

11. The substrate of claim 7 wherein the first, high-gloss macroscopic regions and the second, low-gloss macroscopic regions combine to collectively form a decorative pattern that is observable when visible light is impinged upon the first major side of the substrate and is reflected therefrom.

12. The substrate of claim 1 wherein the substrate comprises a visible light transmission of less than about 10%.

13. The substrate of claim 1 wherein the polymeric material of the polymeric substrate contains at least 2 wt % of an opacifying agent.

14. The substrate of claim 1 wherein the polymeric material of the polymeric substrate comprises an effective amount of at least one coloring agent such that, when visible light is impinged upon the first major side of the substrate and is reflected therefrom, the substrate displays a readily discernible non-white color.

15. The substrate of claim 1 wherein the polymeric material of the polymeric substrate is a semicrystalline thermoplastic polymer.

16. The substrate of claim 1 wherein the substrate is a tape backing.

17. The substrate of claim 16 further comprising a pressure sensitive adhesive disposed on the second major side of the tape backing.

18. The substrate of claim 1 wherein the at least one physical microstructure is a microstructured hand-tear pattern.

19. The substrate of claim 1 wherein the at least one physical microstructure is a microstructured liquid-retention pattern.

20. The substrate of claim 1 wherein the least one physical microstructure comprises a microstructured hand-tear pattern and a microstructured liquid-retention pattern, wherein the microstructured hand-tear pattern and the microstructured liquid-retention pattern are coextensive and intersecting.

21. A method of making a polymeric substrate a first major side with first, high-gloss areas and with second, molded textured low-gloss areas and with at least one physical microstructure that is superimposed on the first and second areas, the method comprising:
contacting a first major surface of a molten polymeric extrudate with a first tooling surface that comprises a negative of the first and second areas and of the physical microstructure, so that the first major surface of the extrudate is molded against the first tooling surface so as to form a polymeric substrate a first major side with first, high-gloss areas and with second, molded textured low-gloss areas and with at least one physical microstructure that is superimposed on the first and second areas.
